(19) United States
(12) Patent Application Publication
(10) Pub. No.: US 2002/0078118 A1
(43) Pub. Date: Jun. 20, 2002

(54) Network interface application specific integrated circuit to allow direct attachment for an appliance,such as a printer device

(76) Inventors: Robert W. Cone, Portland, OR (US); Patrick F. Stolt, Beaverton, OR (US)

Correspondence Address: Dennis M. de Guzman, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/742,264

(22) Filed: Dec. 19, 2000

(51) Int. Cl. G06F 9/00

(52) U.S. Cl. 709/101

(57) ABSTRACT

An application specific integrated circuit (ASIC) allows an appliance, such as a printer device, to be directly attached to a network. The ASIC includes state machines and on-chip storage buffers that perform functions typically performed by processors, memory, and embedded internal software. The state machines process protocols and cooperate with other components of the ASIC to identify a source/destination of data and to throughput the data through the ASIC.

### BACKGROUND OF THE INVENTION

1. Field of the Invention

The present invention relates generally to application specific integrated circuits (ASICs), and in particular, relates to a network interface ASIC that allows direct attachment for an appliance, such as a printer device.

2. Background Information

During the processing and transferring of data between a network and an appliance, such as between an Ethernet local area network (LAN) and a printer or print server, many separate and standard components are used. These components reside in one or more system devices (e.g., reside in a system), and typically include central processing units (CPUs), memory such as random access memory (RAM) and flash memory, network controllers, and internal embedded software. These components cooperate, in a printer setting, to perform functions such as sending network data (e.g., frames or packets) to the printer or to a print queue, obtaining printer status information, obtaining print job status information, determining a source/destination of packets, etc.

Although such system components do perform their designated functions, they are complicated and expensive. That is, such systems are complex due to the number and location of the individual components. The components are typically located on different chips and/or on different devices. One or more processors or CPUs are often required to control operation of the various system components and to run their software programs. The software programs themselves can comprise complex algorithms that inherently produce latency during their execution, thereby sometimes making relatively simple tasks, such as requesting printer status information, inefficient. All of these factors result in significant overhead, inefficiency, complexity, and increases in packaging costs and die size.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an ASIC layout according to an embodiment of the invention.

FIG. 2 represents an embodiment of a packet that can be assembled by the ASIC of FIG. 1.

FIGS. 3-6 are example state machine flow diagrams illustrating operation of an embodiment of a controller of the ASIC of FIG. 1.

FIG. 7 is a state machine flow diagram illustrating operation of an embodiment of a packet processor unit of the ASIC of FIG. 1.

FIG. 8 is a state machine flow diagram illustrating operation of an embodiment of a packet assembler unit of the ASIC of FIG. 1.

### DETAILED DESCRIPTION OF THE ILLUSTRATED EMBODIMENTS

Embodiments of an apparatus and method for providing an appliance, such as a printer device, with the capability to be directly attached to a network via an ASIC, are described herein. In the following description, some specific details are provided, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As an overview, an embodiment of the invention provides an ASIC that substantially removes or reduces the need for standard components (such as a CPU, RAM and flash memory, internal embedded software, and a fully network-standard-compliant network controller) that are typically distributed among several devices in a system. In an embodiment, the ASIC has its own internal first-in-first-out (FIFO) buffers and state machines that cooperate to perform processing typically performed by processors and internal embedded software of the prior art. The result is an ASIC that has considerably less overhead, less packaging costs, and smaller die size, with the ASIC providing a more simplified and efficient alternative to the prior art systems described above.

For illustrative purposes and to simplify the description of various embodiments of the invention, some ASIC components are at times referred to herein in the context of being usable for an Ethernet and/or peripheral component interconnect (PCI) implementation. It is to be appreciated that principles of the invention can be applied to non-Ethernet types of networks or systems, such as AppleNet™, token ring, wireless applications, etc. Additionally, embodiments of the invention may be implemented with non-PCI systems, such as universal serial bus (USB) and InfiniBand systems. Therefore, the invention is not limited by the specific type of network, system, bus, or standard.

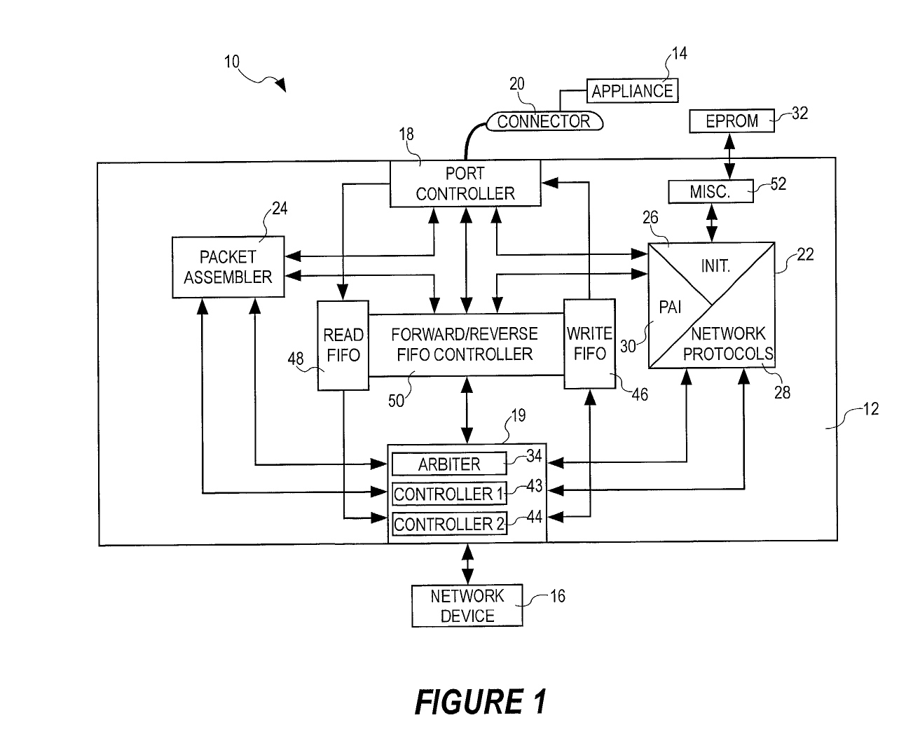

Referring first to FIG. 1, shown generally at 10 is a representation/layout of an ASIC according to an embodiment of the invention. The ASIC 10 has components that are disposed on a substrate 12, with the various arrows shown representing possible data transmission paths and/or control connections. The ASIC 10 allows direct attachment between an appliance 14 and a network having a network device 16. The network device 16 can include network controllers or adapters such as Ethernet controllers, media access control (MAC) controllers, PCI controllers, input/output (I/O) controllers such as small computer system interface (SCSI) controllers, network interface cards (NICs), switches, routers, or other such devices.

Examples of the appliance 14 can include printer devices such as a printer or a print server, graphic display devices, disk drives, or other peripheral devices or parallel port-equipped devices. For illustrative purposes, the appliance 14 is at times described herein in the context of a printer, and it is to be appreciated that some embodiments of the ASIC 10 can be used with other types of appliances 14.

An embodiment of the ASIC 10 comprises four components (along with their corresponding functions): network processing control, port control, FIFO buffer and miscellaneous control, and network device control. The port control component includes a port controller 18 that controls data that is transferred, via a connector 20, between the appliance 14 and components of the ASIC 10. The port controller 18 can also act as an intermediate destination for data transferred between components within the ASIC 10. The network device control component is shown at 19 and includes a simplified hardware version of a typical software device driver for the network device 16. The network device control component 19 will be described in further detail below.

The network processing control component, in an embodiment, comprises a packet processor unit 22 and a packet assembler unit 24. The packet processor unit 22 is used like a general CPU, but without any of the associated software in an embodiment. As will be described in further detail below, the packet processor unit 22 includes a set of state machines (e.g., is state machine-based) that control communication between the appliance 14 and the network device 16. These state machines cooperate with other components of the ASIC 10 to control data throughput and networking protocols. Examples of protocols that can be processed by the packet processor unit 22, using hardware, include transmission control protocol/Internet protocol (TCP/IP), user datagram protocol (UDP), address resolution protocol (ARP), Internet group management protocol (IGMP), Internet control message protocol (ICMP), dynamic host configuration protocol (DHCP), or other network protocols and internal protocols.

In an embodiment, the packet processor unit 22 comprises three internal components, including an initialization unit 26, a network protocol unit 28, and a packet assembler interface (PAI) 30, and a fourth internal component to provide an interface with the network device 16. This fourth internal component can be shared with or located in the network device control component 19.

The packet processor unit 22 may be programmable through an external storage device, such as an erasable programmable read-only memory (EPROM) 32, during power up (e.g., at boot time) of the ASIC 10, which includes configuration of the ASIC 10 by the initialization unit 26 during power up. When power up occurs, the packet processor unit 22 reads stored data from the EPROM 32 and then uses the data to configure the rest of the ASIC 10. The data that is loaded from the EPROM 32 includes the functions of the state machines in the ASIC 10 that support the network and internal protocols identified above. In this manner, the state machines of the ASIC 10 may be re-configurable or programmable based on the data that is stored in and loaded from the EPROM 32. The EPROM 32 may be embedded in or coupled to suitable devices external to the ASIC 10, such as printers, stand-alone computers or personal computers (PCs), cards, etc.

The network protocol unit 28 provides the main controlling component of the packet processor unit 22 in one embodiment. The network protocol unit 28 receives data from the network or the network device 16, processes that data, and then issues commands to the rest of the ASIC 10. The network protocol unit 28 has state machines, programmable by the EPROM 32, which provide for interfacing with different networking protocols, as will be described below.

The packet assembler interface 30 of the packet processor unit 22 controls the data flow of the packet assembler unit 24. Whenever a device connected to the network, such as a host PC, wants to obtain data from the ASIC 10, that device sends a command in a header of a packet or frame. The packet processor unit 22 then processes this data, and sends commands to the packet assembler unit 24 (via the packet assembler interface 30) to acquire the requested data. The requested data can be associated with a request for printer status information or with the host PC's sending of a print job, for example. After the requested data is acquired by the packet assembler unit 24, via the port controller 18, the packet assembler unit 24 or the packet processor unit 22 sends the data to the requesting device through the network device control component 19.

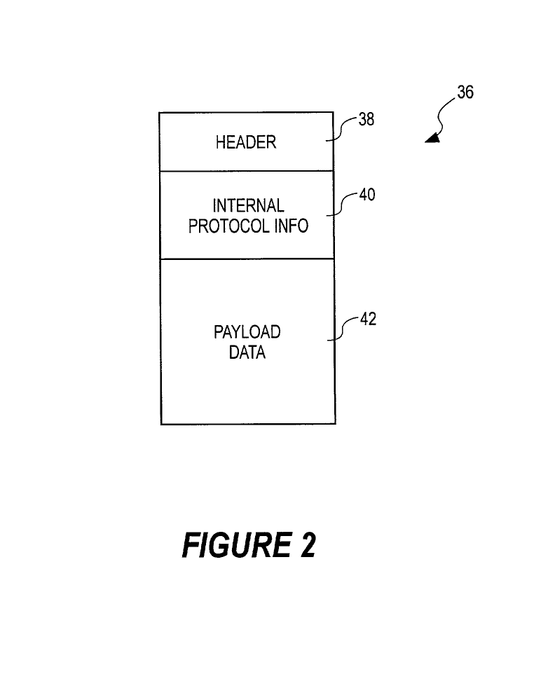

The packet assembler unit 24 is the main transmitting block in the ASIC 10 in one embodiment. As described above, the packet assembler unit 24 is instructed by the packet processor unit 22, via the packet assembler interface 30, to obtain data and send the data out through the network device control component 19. This involves, in one embodiment, assembly or construction of a packet for the network. The packet assembler unit 24 obtains the appropriate data and creates a packet, such as that shown at 36 in FIG. 2, having a header 38, internal or network protocol information 40, and the data in a payload 42. The information at 40 can also include a command for the ASIC 10 with regards to what the ASIC 10 should do with the packet 36. In an embodiment, the packet assembler unit 24 is interrupt-driven from the network device control component 19.

After assembling the packet 36, the packet assembler unit 24 communicates that it is ready to send the packet 36 out to the network. The size of the packet 36 may also be communicated in an embodiment. In one embodiment, these communications from the packet assembler unit 24 is done through an arbiter 34 of the network device control component 19. An embodiment of the arbiter 34 provides arbitration for use of a bus (not shown), such as a PCI bus, with the ASIC 10 and the network device 16 being coupled to the bus. The arbiter 34 arbitrates between the sending and the receiving of data on the ASIC 10 in a manner such that the ASIC 10, the appliance 14, or the network device 16 does not monopolize use of the bus. A suitable and simple design for the arbiter 34 can be implemented by those skilled in the art having the benefit of the description herein of embodiments of the invention, particularly since only two external components (e.g., the appliance 14 and the network device 16) and the ASIC 10 are involved.

The network device control component 19 controls the interface (e.g., a PCI interface) between the ASIC 10 and the network device 16. In an embodiment, the network device control component 19 comprises a state machine-based, simplified hardware version of a typical software device driver for the network device 16. A function of the network device control component 19 is to transfer data between the network device 16 and the ASIC 10 using a simplified transfer mode or operation. The network device control component 19 includes state machines that control the transmitting and receiving of frames/packets from the network, as will be described later below. These state machines can interact, for example, with a shared memory architecture in the network device 16. The network device control component 19 can also tell the network device 16 when to transfer data to the ASIC 10, using the arbiter 34 to acquire control of the bus.

The network device control component 19 includes a first controller 43 in an embodiment. The first controller 43 includes state machines and various levels of logic that simulate a software interface with the network device 16. The first controller 43 can operate similarly to an Ethernet MAC controller, for example. In operation, the packet assembler unit 24 provides information to the first controller 43 with regards to the direction of the data transfer, when data has been received by the network device 16, or when to clear a frame from the network device 16.

The network device control component 19 can include a second controller 44, such as a PCI controller that controls the data flow between the network device 16 and the ASIC 10 via PCI. In an embodiment, the second controller 44 includes logic that performs PCI bus protocol, using a general PCI base of logic, and is limited to only the minimum functionality required for connection to the external network device 16. Therefore, in this embodiment, the second controller 44 is not, and does not need to be, 100% PCI-compliant or fully compliant with other standards, thereby allowing it to have a simplified design.

The ASIC 10 includes a storage unit, such as a write FIFO buffer 46 (e.g., a receive FIFO buffer) and a read FIFO buffer 48 (e.g., a transmit FIFO buffer). Suitable implementations for the FIFO buffers 46 and 48 include blocks of memory, RAM, static RAM (SRAM), or other types of machine-readable storage media typically used to temporarily hold or store data. A forward/reverse FIFO controller 50 controls which FIFO buffer 46 or 48 is forwarding data at any instant of time (e.g., the direction of data throughput), thereby avoiding packet collisions or packet overruns. In an embodiment, the FIFO controller 50 makes these determinations based on control signals sent from the packet processor unit 22, from the packet assembler unit 24, or from the port controller 18. With the use of the FIFO buffers 46 and 48 to provide storage and delay, data throughput and direction through the ASIC 10 can be controlled to allow the various state machines within the ASIC 10 to have sufficient time to sequentially process the data and determine their destinations. For example, in an embodiment, the forward/reverse FIFO controller 50 and the FIFO buffers 46 and 48 cooperate such that the ASIC 10 is not transmitting data when it should be receiving data, and vice versa.

In operation, the write FIFO buffer 46 receives data or packets from the network device 16 and then transfers that data to the port controller 18. While the data is at the port controller 18, the network protocol unit 28 examines the data (e.g., by examining the packet header information using state machines) to determine the source and destination of the packet and to process the protocol(s) corresponding to the data. Once this information is determined, the network protocol unit 28 allows the port controller 18 to route the data to its destination, such as to the appliance 14. In one embodiment, the data sent from the network device 16 is not reassembled into a new packet by the packet assembler unit 24 before the data arrives at the port controller 18, while in another embodiment, the packet assembler unit 24 may perform some packet assembly prior to the data's arrival at the port controller 18.

For the transmitting of data, the read FIFO buffer 48 receives data from the port controller 18 and then transmits data out of the ASIC 10 to the network device 16, via PCI for example. In one embodiment, the data sent from the port controller 18 to the network device 16 is not assembled into a packet by the packet assembler unit 24, while in another embodiment, the packet assembler unit 24 may perform some packet assembly prior to the data's arrival at the network device control component 19, in a manner similar to that shown in FIG. 2. While the data is at the port controller 18, at the read FIFO buffer 48, or at the packet assembler unit 24, the network protocol unit 28 can examine the data (e.g., by examining the packet header information using state machines) to determine the source and destination of the packet, as well as to process the appropriate protocol(s).

The ASIC 10 can further include miscellaneous controllers 52. In an embodiment, miscellaneous controllers 52 include an interface to the EPROM 52, timers, a test page generator, and speed controllers.

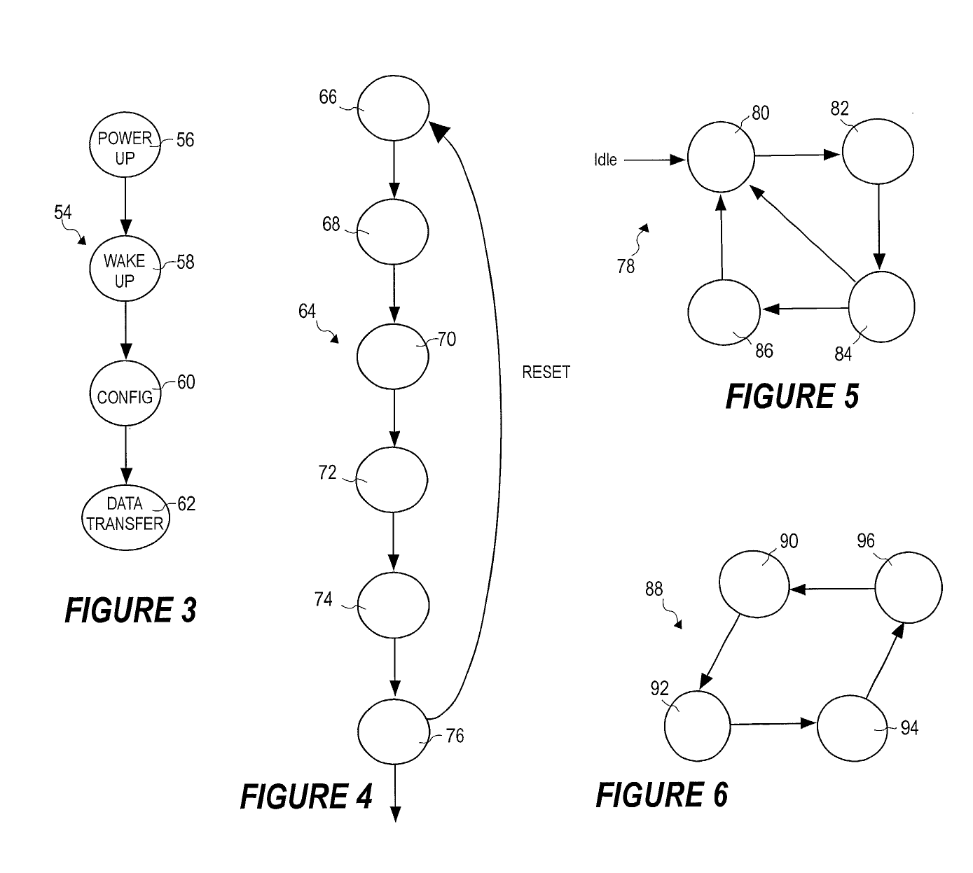

Shown next in FIG. 3 is a flow diagram representing operation of an embodiment of a main state machine(s) 54 in the first controller 43. A power-up state 56 is the first state of the state machine 54 when power is asserted. The main state machine 54 stays in this state for a period of time and then goes to a wake-up state 58. The wake-up state 58 is a state where the packet processor unit 22 sets up all internal registers, and where the main state machine 54 waits for an interrupt from the packet processor unit 22.

A configuration state 60 sets up or configures the network device 16. A state machine 64 shown in FIG. 4 can be used for configuration of the network device 16. When configuration is completed at the configuration state 60, the state main machine 54 moves to a data transfer state 62. The data transfer state 62 starts a receive state machine 78 and a transmit state machine 88, shown respectively in FIGS. 5 and 6.

The configuration state machine 64 shown in FIG. 4 can be included as part of the first controller 43, and starts at a global reset state 66. At a link initialization state 68, a link with the network device 16 is established by enabling a link interrupt and waiting for the link interrupt. At a next state 70, a status register of the network device 16 is checked for mode and speed. Based on the information obtained from the status register, the first controller 43 is set to the appropriate speed and for duplex operation, for example.

At a state 72, transmit and receive descriptor registers are set up. These registers map the ASIC's 10 memory location into the network device 16. Receive and transmit timers are set up at a next state 74. These timers indicate when data has been transmitted or received. A factor that can be used to set the length of the timers is the size of the packet 36, which may be determined from a descriptor ring. Receive and transmit control registers are set up at a state 76. These registers enable data to be transferred.

The first controller 43 can include the receive state machine 78 of FIG. 5, which is used when the ASIC 10 is receiving packets from the network device 16. At an idle state, the receive state machine 78 waits for the main state machine 54 to enter the data transfer state 62. The receive state machine 78 also goes back to the idle state during a reset. At a state 80, a tail pointer of a descriptor ring is advanced, to inform the network device 16 to start transmitting packets, when the network device 16 receives requests for the packets.

At a state 82, a value in a data counter of the ASIC 10 is incremented with each incoming data byte. The state 82 waits for a receive timer interrupt and allows the incoming packet's length to be obtained from the packet (e.g., by reading header information). Use of the data counter in conjunction with the packet length allows the first controller 43 to determine whether the write FIFO buffer 46 is ready to take additional packet(s).

For example, the value in the data counter is compared with the packet size at a state 84. If the value in the data counter does not equal the packet size, then this indicates that the write FIFO buffer 46 can accept additional packets. As such, the receive timer interrupt is cleared, and the receive state machine 78 goes to the state 80 to inform the network device 16 to continue transmitting packets.

If, however, the value in the data counter equals the packet size, then this indicates that the write FIFO buffer 46 is full and cannot accept additional packets. As a result, the receive timer interrupt is cleared, and the receive state machine 78 goes to a state 86. At the state 86, the first controller 43 stops the transfer of packets from the network device 16, and flags the packet processor unit 22 that the write FIFO buffer 46 is full. The receive state machine 78 then waits until the write FIFO buffer 46 is empty and/or has space to accept additional packets.

The first controller 43 can include the transmit state machine 88 of FIG. 6, which is used when the ASIC 10 is transmitting packets to the network device 16. At a state 90, a descriptor length register is set up to inform the network device 16 of the length of the data to be transferred. A tail pointer of a descriptor ring is advanced at a state 92 to start the data transfer. The transmit state machine 88 waits for a transmit timer interrupt at a state 94. At a state 96, the transmit timer interrupt is cleared. The first controller 43 also notifies the packet assembler unit 24 and the packet processor unit 22, at the state 96, when the data transfer is complete, thereby allowing additional packets to be prepared for transmission.

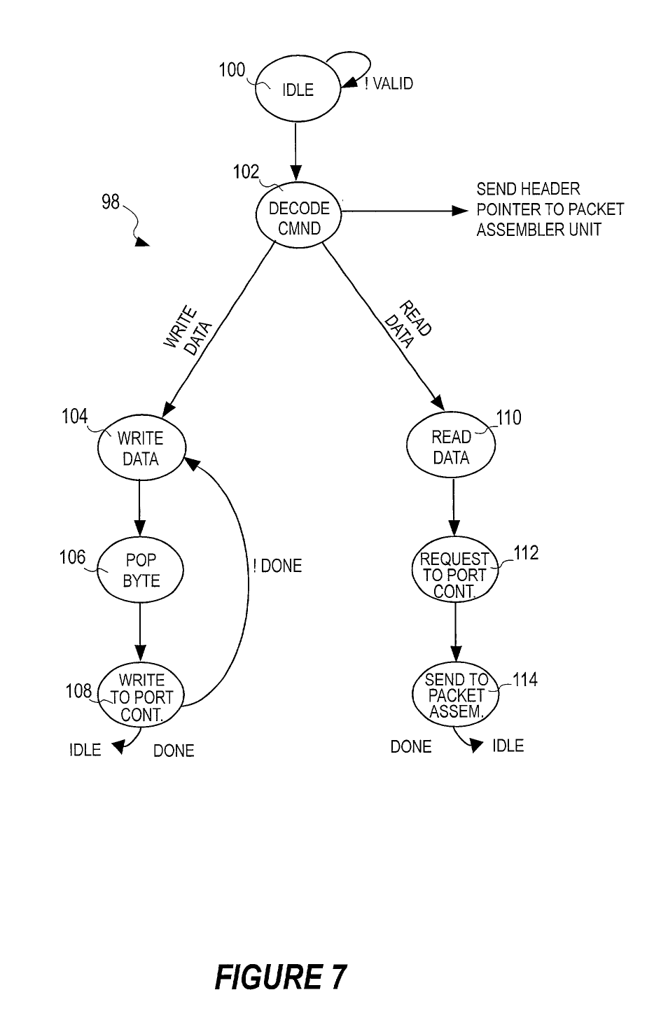

Shown next in FIG. 7 is a flow diagram representing operation of an embodiment of a packet processor state machine 98 for the packet processor unit 22. The packet processor state machine 98 may form part of the network protocols unit 28, for example. The packet processor state machine 98 processes packets as received by the ASIC 10 and executes the commands as defined in the packet(s). An example assumption is that any packet received at the write FIFO buffer 46 is for the ASIC 10 and destined for the appliance 14 (e.g., printer) connected to it. The operation of the packet processor state machine 98 involves decoding a packet command in the packet payload once the packet is valid. Afterwards, operation of the packet processor state machine 98 involves transferring the data/packet to the port controller 18 in the case of writes to the appliance 14, or sending information to the packet assembler unit 24 in the case of reads from the appliance 14.

As described above with reference to FIG. 2, the packet 36 can comprise three parts: the header 38, the ASIC command 40 (which may be the first byte of the payload 42), and the data (the remainder of the payload 42). The header 38 can be a standard IP header, although other types of headers can be supported through a configurable update mechanism for the packet processor state machine 98. The header 38 can also contain the length of the payload 42, which is used in further processing.

At an idle state 100, the packet processor state machine 98 remains idle until a valid packet is received. Once a valid packet is received, the packet processor state machine 98 transitions to a decode state 102. During the decode state 102, the command in the packet 36 is decoded to determine what further processing is required. A header pointer may also be sent to the packet assembler unit 24.

If the decode state 102 determines that data is to sent/written to the appliance 14, then the packet processor state machine 98 transitions to a write data state 104. Data in the payload 42 is transferred one byte at a time to the port controller 18 and/or to its handler at states 106 and 108, until the end of the packet 36 is achieved (sometimes referred to as “popping a byte” to take a byte off a stack). An acknowledgement is generated by the packet assembler unit 24 to indicate completion or error conditions. To trigger generation of the acknowledgement, data is passed to the packet assembler unit 24.

If the decode state 102 determines that data is to received/read from the appliance 14, then the packet processor state machine 98 transitions to a read data state 110. Request(s) to the port controller 18 are sent at a state 112 to obtain information, such as printer type or printer status. Once the requested information is obtained, the information is sent to the packet assembler unit 24 for ultimate transmission to the network device 16.

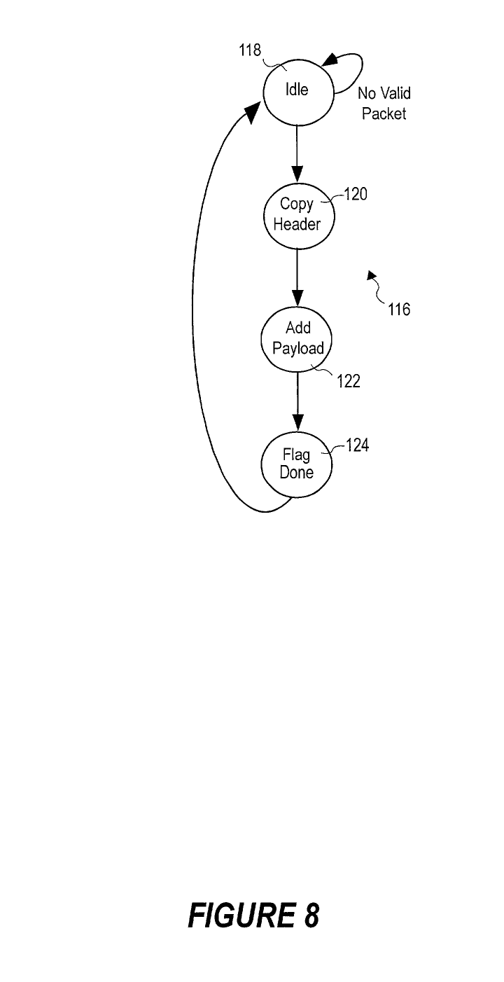

Shown next in FIG. 8 is a flow diagram representing operation of an embodiment of a packet assembler state machine 116 for the packet assembler unit 24. Packet assembly involves development of a header and payload in the read FIFO buffer 48, which in one embodiment occurs during situations when data is to be sent from the port controller 18 to the network device 16. The destination address can be copied from the source address of the originating packet. The length of the packet 36 may be fixed in an embodiment, since only one byte is to be transferred in many cases. Also in case(s) where the length of the packet 36 is larger (e.g., read printer information), the length of the packet 36 is also fixed in size. The data in the payload 42 can indicate, for example, that the packet 36 was transferred to the appliance 14 correctly or the identification (ID) for an error, if an error occurred. At the end of the packet assembly, a flag is sent to the network device control component 19 for transfer of the packet 36 back to the originator.

The states of the packet assembler state machine 116 are as follows. At an idle state 118, the packet assembler state machine 116 waits for a valid packet to be received. When a valid packet is received, the packet processor unit 22 sends a pointer of a start of header in the incoming/receive FIFO buffer (e.g., the write FIFO buffer 46) to the packet assembler unit 24. At a state 120, the header for the received packet is copied from the receive FIFO buffer. The source and destination addresses from the original packet are reversed when assembling the packet 36, and the payload size from the original packet is modified to a fixed size.

Next at a state 122, the payload 42 is then added using data obtained from the port controller 18. Once the packet 36 is completed at a state 124, a flag is sent by the packet assembler state machine 116, for example, to the network device control component 19 to indicate that the packet 36 is ready for transfer to the network device 16. The packet assembler state machine 116 then returns to the idle state 118.

In one embodiment, every packet 36 gets acknowledged. For instance, there may be three possible payloads in situations (and acknowledgements) when the appliance 14 is a printer device: packet transfer successful (1 byte), printer error (1 byte), and printer information (1 byte).

In conclusion, an embodiment of the invention provides a processorless solution to the transfer of data between the appliance 14 and the network device 16, by using the ASIC 10 to allow direct attachment of the appliance 14 to the network device 16. The ASIC 10 uses state machines and on-chip storage buffers to perform protocol processing and data/packet processing typically performed by CPUs, RAM and flash memory, and embedded internal software. By eliminating or reducing the need for these standard components, the ASIC 10 uses less overhead, is less costly, and has a smaller die size.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

For example, while FIG. 1 shows specific elements as residing in the packet processor unit 22 or in the network device control component 19, it is to be appreciated that some of these elements can be combined/shared between these two components or can reside elsewhere on the ASIC 10 in another embodiment. Such elements can include all or parts of the various state machines described above. In another modification, the various functions performed by the first controller 43 and by the second controller 44 can be combined into or performed by a single controller.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus, comprising:
a state-machine-based network protocol unit disposed on an integrated circuit, the network protocol unit having state machines to control other units of the integrated circuit and to process a network protocol corresponding to data throughput through the integrated circuit; and
a storage unit disposed on the integrated circuit and coupled to the network protocol unit, the storage unit responsive to the network protocol unit to store and to control direction of the data throughput through the integrated circuit.

2. The apparatus of claim 1 wherein the storage unit comprises:
a first buffer to temporarily store data throughput through the integrated circuit in a first direction;
a second buffer to temporarily store data throughput through the integrated circuit in a second direction different from the first direction; and
a controller coupled to the first and second buffers and responsive to the state machines to determine which of the first or second buffers forward their respective stored data.

3. The apparatus of claim 1 wherein the network protocol unit comprises part of a packet processor unit, the packet processor unit including:
an initialization unit to read information external to the integrated circuit and to use that information to program the state machines; and
a packet assembler interface through which to provide commands related to data throughput within the integrated circuit.

4. The apparatus of claim 3, further comprising a packet assembler unit disposed on the integrated circuit and coupled to the packet assembler interface to receive the commands, the packet assembler unit responsive to the commands to retrieve data and to assemble a packet having header information and the retrieved data.

5. The apparatus of claim 3, further comprising a state-machine-based network device control component disposed on the integrated circuit and coupled to the packet processor unit, the network device control component having state machines to control transmission of packet data from the integrated circuit to a network device and reception of packet data from the network device to the integrated circuit.

6. The apparatus of claim 5 wherein the network device control component includes:
an arbiter to arbitrate for bus use associated with the transmission and the reception of the packet data;
a first controller having logic to determine direction of the packet data; and
a second controller having logic to perform bus protocol associated with the packet data.

7. The apparatus of claim 4, further comprising a port controller disposed on the integrated circuit and coupled to the packet processor unit, the port controller being capable to control transmission of data from the integrated circuit to an appliance and reception of data from the appliance to the integrated circuit.

8. The apparatus of claim 3, further comprising a controller disposed on the integrated circuit and coupled to the initialization unit, the controller having an interface to receive the external information to program the state machines and to provide the received external information to the initialization unit.

9. The apparatus of claim 5 wherein the state machines of the network device control component include:
a first state machine to interface the network device control component to the network device;
a second state machine to control reception of packet data sent from the network device to the integrated circuit; and
a third state machine to control transmission of packet data sent from the integrated circuit to the network device.

10. The apparatus of claim 4 wherein the state machines include:
a first state machine associated with the packet processor unit to control processing of the data throughput through the integrated circuit; and
a second state machine associated with the packet assembler unit to control assembly of the packet.

11. A system, comprising:
an appliance;
a network device; and
an integrated circuit coupled between the appliance and the network device to receive data transmitted between the appliance and the network device, the integrated circuit including:
a state-machine-based packet processor unit having state-machines to control other units of the integrated circuit and to process a network protocol corresponding to data throughput through the integrated circuit; and
a storage unit coupled to the packet processor unit and responsive to the packet processor unit to store and to control direction of the data throughput through the integrated circuit.

12. The system of claim 11 wherein the appliance comprises a printer device.

13. The system of claim 11 wherein the storage unit comprises:
a first buffer to temporarily store data throughput through the integrated circuit from the appliance to the network device;
a second buffer to temporarily store data throughput through the integrated circuit from the network device to the appliance; and
a controller coupled to the first and second buffers and responsive to the state machines to determine which of the first or second buffers forward their respective stored data.

14. The system of claim 11 wherein the packet processor unit includes an initialization unit to read information external to the integrated circuit and to use that information to program the state machines, the system further comprising a storage device external to the integrated circuit having the external information stored therein and readable by the initialization unit.

15. The system of claim 11 wherein the integrated circuit further comprises:
a packet assembler unit coupled to the packet processor unit to receive commands related to data throughput within the integrated circuit, and being responsive to the commands to retrieve data and to assemble a packet having header information and the retrieved data; and
a state-machine-based network device control component coupled to the packet processor unit and to the packet assembler unit, the network device control component having state machines to control transmission of packet data from the integrated circuit to the network device and reception of packet data from the network device to the integrated circuit.

16. A method, comprising:
using state machines disposed on an integrated circuit to process network protocol information associated with data receivable by the integrated circuit;
determining a destination of the data using the state machines;
storing the data in a storage unit disposed on the integrated circuit and forwarding the stored data from the storage unit to the destination based on a command from the state machines.

17. The method of claim 16, further comprising:
using the state machines to issue a command related to a request for data;
in response to the command, assembling a packet having header information and the requested data; and
transmitting the assembled packet to a network device that requested the data via a state-machine-based bus protocol controller.

18. The method of claim 16, further comprising programming the state machines using information stored externally to the integrated circuit and loaded on to the integrated circuit during power up.

19. The method of claim 17 wherein the state machines include:
a first state machine to control processing of the command related to the request for data; and
a second state machine to control assembly of the packet having the header information and the requested data.

20. The method of claim 16 wherein the state machines include:
a first state machine to interface the integrated circuit to a network device;
a second state machine to control reception of data sent from the network device to the integrated circuit; and
a third state machine to control transmission of data sent from the integrated circuit to the network device.
